(19) United States
(12) Patent Application Publication
(10) Pub. No.: US 2011/0003134 A1
(43) Pub. Date: Jan. 6, 2011

(54) Water-tight and water vapor-permeable membrane

(76) Inventor: Bodo W. Lambertz, Pfaffikon (CH)

Correspondence Address: Olson & Cepuritis, LTD., 20 NORTH WACKER DRIVE, 36TH FLOOR, CHICAGO, IL, 60606, US

(21) Appl. No.: 12/803,647

(22) Filed: Jul. 1, 2010

(30) Foreign Application Priority Data
Jul. 2, 2009 (DE) 20 2009 009 176.7

(51) Int. Cl. B32B 5/24; B32B 9/00; D06N 7/00

(52) U.S. Cl. 428/311.51; 428/311.11; 977/961

(57) ABSTRACT

The invention concerns a water-tight and water vapor-permeable membrane consisting of at least one membrane foil, whereby two membrane foils (21, 22) are provided, between which nanofibers (23) are positioned.

### BACKGROUND OF THE INVENTION

This invention relates to water-tight and water vapor-permeable membrane materials used for items of clothing.

Water-tight materials used for items of clothing have in the past had the great disadvantage that they were also impermeable to water vapor, so that the moisture produced by the body in the form of sweat, which represents an important mechanism for the regulation of the body temperature, could not be removed, or could only be removed inadequately. The lack of removal of sweat leads to the formation of a condensate on the inner side of the clothing, so that this becomes damp and gives the wearer an unpleasant feeling. The use of breathable fabrics has, to be sure, generally made the evaporation of the accumulating sweat possible; but at the same time, however, these items of clothing were not able to keep water from the skin, since they were not simultaneously water-tight and breathable.

Membranes durably and flexibly glued or laminated to textiles have been developed to eliminate this disadvantage. The composite material thereby arising has a micro-pored, air-permeable layer that is permeable to water and vapor. A distinction is made between membranes that have pores (such as “Gore-Tex®”, for example) and membranes that do without pores (such as “Sympatex®”, for example). The membranes are tight against water and wind; but body moisture can still pass through/diffuse through the membrane in the form of water vapor, however. The membrane is consequently breathable.

The diffusion of water vapor through the membrane is brought about through the difference, in pressure between the temperature prevailing underneath the clothing and the ambient temperature. Insofar as the temperature underneath the item of clothing is clearly greater than the ambient temperature, an equalization of pressure takes place through the membrane because of the need of nature to produce an equilibrium, upon which the water vapor is removed to the outside.

In the known membranes, an even diffusion of the water vapor takes place over the entire surface of the membrane. Consequently, the possibility of bringing about different diffusion characteristics inside the membrane only exists through the use of different membranes inside an item of clothing. Through the combination of different membranes that is consequently necessary, the production of an item of clothing provided with the same is complicated and thereby expensive.

### SUMMARY OF THE INVENTION

The invention is meant to provide help here. The task that forms the basis of the invention is that of providing a water-tight and water vapor-permeable membrane that provides areas of different diffusion characteristics in accordance with the requirements without the combination of different membranes. This task is solved in accordance with the invention through the characteristics of patent claim 1.

A water-tight and water vapor-permeable membrane is created by means of the invention, which provides areas of different diffusion characteristics without thereby having to combine different membranes with one another. It is thereby possible to adjust the membrane to the specific requirements. Thus, for example, the possibility exists of providing items of clothing with a section with improved diffusion characteristics in the area of greater sweat accumulation, but of only providing the adjacent sections with conventional diffusion characteristics, however.

Other developments and embodiments of the invention are described hereafter.

### BRIEF DESCRIPTION OF THE DRAWING

One embodiment of the invention is depicted in the drawing and is described in greater detail below. The figures show:

FIG. 1. A perspective representation of the layers of a multi-layer, water-tight and water vapor-permeable material;

FIG. 2. A view from above of a membrane foil with nanofibers applied;

FIG. 3. A view from above of a membrane foil with nanofibers applied in another embodiment; and:

FIG. 4. A cross-section through a membrane in accordance with the invention.

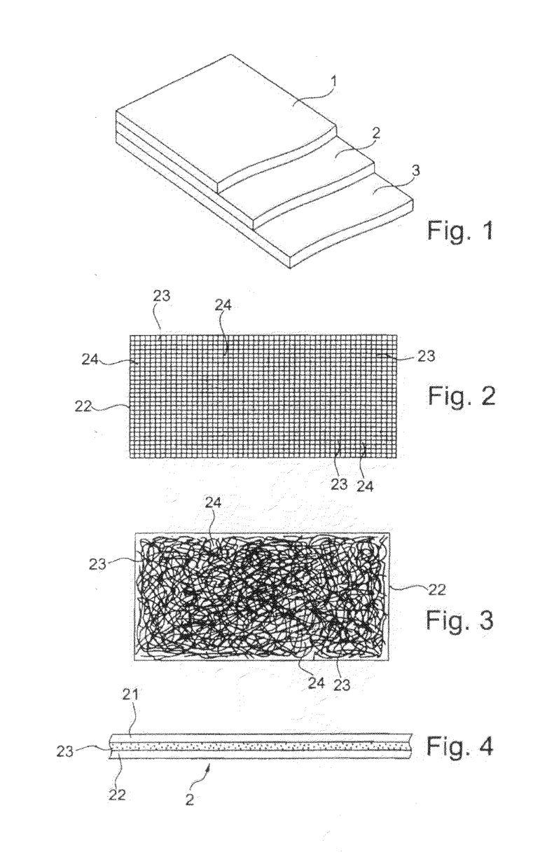

### DETAILED DESCRIPTION OF THE INVENTION

In one embodiment, a water-tight and water vapor-permeable material for use in the item of clothing is depicted, which is constructed in a multi-layer manner. This consists of an upper material 1, which can be selected freely in accordance with the area of application. This may thereby involve material suitable for each item of clothing, for example. A membrane 2 is positioned underneath the upper material 1; underneath the membrane 2, a lining material 3 forms the inner side of the specific item of clothing. Any type of material that is used in the textile industry can be used as a lining material. Materials that include a pleasant wearing comfort for the skin are obviously preferred here. The membrane 2 is connected with the upper material 1, as well as with the lining material 3 durably and flexibly.

The membrane 2 is formed in a multi-layer manner (FIG. 2). It consists of a first membrane foil 21, which is positioned on the side oriented towards the upper material 1, and of a second membrane foil 22, which is positioned on the side oriented towards the lining material 3.

In the embodiment, the membrane foils 21 and 22 are non-porous, hydrophobic foils of polyester into which the hydrophilic molecule components are integrated. The foils are thus wind-tight and water-tight, but at the same time make possible a diffusion of water vapor, however, so that body moisture can pass through the membrane 2. As a variation from the embodiment, membrane foils provided with pores can also be used.

Fibers 23 are positioned between the membrane foils 21 and 22. The fibers 23 are nanofibers that have an extraordinarily small diameter that is approximately 200 to 500 times smaller than the human hair. The fibers preferably have a diameter of 50 nanometers. In the embodiment, the nanofibers consist of carbon; this involves a carbon fiber. The possibility also exists, however, of using nanofibers on the basis of polymer materials, metals, metal oxides, ceramics, or glass.

Gaps 24 are formed between the nanofibers 23. The number and size of the gaps 24 depend on the number and the density of the fibers 23. The more densely the fibers 23 are placed next to one another, the smaller are the dimensions of the gaps 24. The number of gaps 24 can likewise be adjusted by increasing the number of fibers 23. The diffusion characteristics of the membrane 2 can be adjusted through the adjustability of the number and the size of the gaps 24. The more fibers 23 are positioned between the membrane foils 21 and 22, the lower are the diffusion characteristics. In the reverse case, in which fewer fibers 23 are positioned between the membrane foils 21 and 22, improved diffusion characteristics result. In a corresponding manner, the embodiment in accordance with FIG. 2 has lower diffusion characteristics than the embodiment in accordance with FIG. 3, since the gaps 24 are larger in this than they are in FIG. 2.

Upon the production of the material in accordance with the invention, nanofibers 23 are first of all applied to the first membrane foil 21. This can be carried out by weaving in the fibers 23. A dispersing of the fibers 23 is also possible. The type of application of the nanofibers 23 depends on the length of the fibers, among other points. Short fibers, such as are depicted in FIG. 3, for example, can be dispersed on in a simple manner, whereas long fibers 21 (FIG. 2) are more suitable for weaving into the fibers. Upon the dispersing of the fibers, a somewhat irregular pattern results, whereas a regular pattern results upon the weaving in or the application of the fibers 23 to the foil 21.

At the end of the application of the fiber 23, the second membrane foil 22 is applied to the fibers 23 located on the first membrane foil 21. The membrane foils 21 and 22 are not subsequently detachably connected with the fibers 23 located between them; the foils 21 and 22 are laminated, through which the membrane 2 is produced. The membrane 2 thus produced is adhered to the upper material 1 as well as the lining material 3 in a durable and flexible manner, so that the material provided for the item of clothing is completed.

By means of the membrane in accordance with the invention, the possibility is provided for changing the diffusion characteristics of the membrane 2. The diffusion characteristics of the membrane 2 are reduced through the provision of a very large number of fibers 23. This results from the fact that the density of fibers 23 is increased, as the result of which the overall size of the gaps 24 is reduced. In contrast to this, the surface formed by the gaps 24 is enlarged overall upon a reduction of the density of the fibers 23, through which increased diffusion characteristics result. By means of this variation in accordance with the invention of the diffusion characteristics of the membrane 2, the possibility exists of providing the membrane 2 with a relatively low density of fibers 23 on particularly sweat-prone areas of the item of clothing, such as the back, the chest, or the armpits, for example, so that the membrane has particularly good diffusion characteristics in these body areas that are strongly affected by the accumulation of sweat. On the other hand, a higher density of fibers 23 can be used in body areas with less accumulation of sweat, as the result of which the diffusion characteristics of the membrane 2 are reduced. The possibility consequently exists of providing areas of the membrane 2 in the specific item of clothing which are specifically adjusted to the different areas of the body, through which the cooling characteristics of the item of clothing are improved in relation to known items of clothing provided with membranes.

1. A water-tight and water vapor-permeable membrane consisting of at least one membrane foil, characterized in that, two membrane foils (21, 22) are provided, between which nanofibers (23) are positioned.

2. A membrane in accordance with claim 1, characterized in that, the nanofibers (23) have a diameter of 50 nanometers.

3. A membrane in accordance with claim, characterized in that, the nanofibers (23) consist of carbon.

4. A membrane in accordance with claim, characterized in that, the nanofibers (23) consist of polymer materials.

5. A membrane in accordance with claim 1, characterized in that gaps (24) are formed between the nanofibers (23).

6. A membrane in accordance with claim 2, characterized in that gaps (24) are formed between the nanofibers (23).

7. A membrane in accordance with claim 6, characterized in that, the number and size of the gaps (24) depend on the number and the density of the nanofibers (23).

8. A membrane in accordance with claim 1, characterized in that, the nanofibers (23) are dispersed on the membrane foil (21, 22).

9. A membrane in accordance with claim 1, characterized in that, the nanofibers (23) are spun into the membrane foil (21, 22).

10. A membrane in accordance with claim 2 characterized in that the nanofibers (23) consist of carbon.

11. A membrane in accordance with claim 2 characterized in that the nanofibers (23) consist of polymer materials.

12. A membrane in accordance with claim 5, characterized in that, the number and size of the gaps (24) depend on the number and density of the nanofibers (23).

13. A membrane in accordance with claim 2, characterized in that, the nanofibers (23) are dispersed on the membrane foil (21, 22).

14. A membrane in accordance with claim 2, characterized in that, the nanofibers (23) are spun into the membrane foil (21, 22).
